(19) United States
(12) Patent Application Publication
(10) Pub. No.: US 2007/0268900 A1
(43) Pub. Date: Nov. 22, 2007

(54) Apparatus and method for allocating resources in multi-carrier telecommunication system

(75) Inventors: Dae-Young Park, Seoul (KR); Seo-Shin Kwak, Anyang-si (KR); Han-Byul Seo, Seoul (KR); Byeong-Gi Lee, Seoul (KR)

Correspondence Address: THE FARRELL LAW FIRM, P.C., 333 EARLE OVINGTON BOULEVARD, SUITE 701, UNIONDALE, NY, 11553, US

(73) Assignees: Samsung Electronics Co., Ltd., Suwon-si (KR); Seoul National University Industry Foundation, Seoul (KR)

(21) Appl. No.: 11/801,562

(22) Filed: May 10, 2007

(30) Foreign Application Priority Data
May 22, 2006 (KR) 10-2006-0045637

(51) Int. Cl. H04L 12/56

(52) U.S. Cl. 370/390

(57) ABSTRACT

An apparatus and method for allocating resources in multi-carrier wireless telecommunication system is provided. The apparatus comprises a scheduler for configuring a multicast channel by combining sub-carriers according to a multicast preference for each sub-carrier, and controlling resource allocation according to the configured multicast channel, and a sub-carrier mapper for inputting unicast data and multicast data to be transmitted, allocating the multicast data to the sub-carriers configuring the multicast channel under the control of the scheduler, and outputting the unicast data by allocating the unicast data to sub-carriers excluding sub-carriers allocated to the multicast channel.

### PRIORITY

This application claims priority under 35 U.S.C. § 119 to an application entitled “Apparatus and Method for Allocating Resources in Multi-carrier Telecommunication System” filed in the Korean Intellectual Property Office on May 22, 2006 and assigned Serial No. 2006-45637, the contents of which are incorporated herein by reference.

### BACKGROUND OF THE INVENTION

1. Field of the Invention

The present invention relates generally to an apparatus and method for allocating resources in multi-carrier wireless telecommunication system. In particular, the present invention relates to an apparatus and method for effectively allocating resources when multicast services and unicast services are commonly being used in multi-carrier telecommunication system.

2. Description of the Related Art

Nowadays, many wireless telecommunication technologies have been proposed for high speed mobile telecommunications. The Orthogonal Frequency Division Multiplexing (OFDM) scheme is currently being studied for use in the next generation wireless telecommunication technology. The OFDM scheme is expected to be used in the field of most wireless telecommunication technology in the near future. The Wireless Metropolitan Area Network (WMAN) in the Institute of Electrical and Electronic Engineers (IEEE) 802.16 standard, which is referred to as the 3.5 generation, has also adopted the OFDM method as a standard technology.

A the telecommunication industry is growing, services provided by the telecommunication systems have developed into multicasting multimedia telecommunication transmitting a large amount of data such as packet data as well as voice services.

To support this multicasting multimedia telecommunications, the following multicast services are provided: Multimedia Broadcast and Multicast Service (MBMS) or the 3^{rd} Generation Partnership Project (3GPP) Broadcast/Multicast Service (BCMCS), which are schemes in which sender transmits the same data to receivers at the same time. A sender transmits one data and then each receiver gets a copy set. A sender transmits the data to the receivers of multicast group that want to get them.

The unicast service, in general, is a scheme in which a sender transmits data packets to a receiver.

In order to provide this multicast service, it is necessary to group the users that want to receive the same data. In the case of applying Modulation and Coding Scheme (MCS), though users request same data service, data transmission rate that each user can receive may not be same because their channel conditions differ from each other. That is, data should be sent at the low MCS level transmission rate for many-users of multicast group to receive multicast data because allowed transmission rates differ from each other. But, if too low of a MCS level data were transmitted to provide multicast services for many users, the entire throughput of system would fall. Therefore, various multicast services were proposed to optimize established throughput.

However, existing skills cannot be applied under the condition where two services exist together because they are considered only on the base of multicast service. A future system cannot provide both unicast service and multicast service at the same time. Therefore, a scheme is required for effectively transmitting data under the condition where both services exist together.

### SUMMARY OF THE INVENTION

An object of the present invention is to substantially solve at least the above problems and/or disadvantages and to provide at least the advantages below. Accordingly, an object of the present invention is to provide an apparatus and method to increase transmission efficiency in a multi-carrier telecommunication system.

Another object of the present invention is to provide an apparatus and method to service multicast service and unicast service at the same time in a multi-carrier telecommunication system.

A further object of the present invention is to provide an apparatus and method transmitting at a required multicast rate to increase transmission efficiency in a multi-carrier telecommunication system.

According to one aspect of the present invention, there is provided an apparatus for allocating resources in multi-carrier telecommunication system, the apparatus includes a scheduler for configuring a multicast channel by combining sub-carriers according to a multicast preference for each sub-carrier, and controlling resource allocation according to the configured multicast channel, and a sub-carrier mapper for receiving a unicast data and multicast data to be transmitted, allocating the multicast data to the sub-carriers, configuring the multicast channel under the control of the scheduler, and outputting the unicast data by allocating the unicast data to the other sub-carriers except the multicast channel.

According to another aspect of the present invention, there is provided a method for allocating resources in multi-carrier telecommunication system, the method includes configuring a multicast channel by combining sub-carriers according to multicast preference for each sub-carrier, allocating data to be transmitted to the sub-carriers, configuring the multicast channel, and allocating a unicast data to be transmitted to the other sub-carriers except the multicast channel.

According to further aspect of the present invention, there is provided a method for allocating resources in multi-carrier telecommunication system, the method includes forming a first set with sub-carriers that are not allocated to multicast, forming a second set with users that do not satisfy a required multicast rate R_{req}, calculating multicast preference of the second set for each sub-carrier in the first set, including a sub-carrier corresponding to a maximum value among the calculated preferences to a multicast channel; excluding a sub-carrier included in the multicast channel from the first set; updating the second set; and configuring the multicast channel by repeating the above steps until the second set is a null set.

### BRIEF DESCRIPTION OF THE DRAWINGS

The above and other objects, features and advantages of the present invention will become more apparent from the following detailed description when taken in conjunction with the accompanying drawing in which:

FIGS. 1A and 1B are graphs illustrating the performance of Frame Error Rate (FER) according to sub-carrier combining (SC);

FIG. 2 illustrates a block diagram of a transmitter in multi-carrier wireless telecommunication system in accordance with the present invention;

FIG. 3 is a flowchart showing resources allocation procedure to service a unicast service and a multicast service at once in multi-carrier wireless telecommunication system in accordance with the present invention;

FIG. 4 is a graph illustrating the relation between required multicast rate and total unicast throughput;

FIG. 5 is a graph illustrating the relation between required multicast rate and outage probability;

FIG. 6 is a graph illustrating the relation between the number of multicast user and total unicast throughput;

FIG. 7 is a graph illustrating the relation between the number of multicast user and outage probability; and

FIG. 8 illustrates a diagram of multicast data and data transmission in accordance with the present invention.

### DETAILED DESCRIPTION OF THE PREFERRED EMBODIMENT

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention will be described as a scheme for effectively providing multicast service and unicast service at the same time in a multi-carrier telecommunication system.

The rate of channel combining a plurality of sub-carriers with different rates can be approximated to equal the sum of the rate for each sub-carrier.

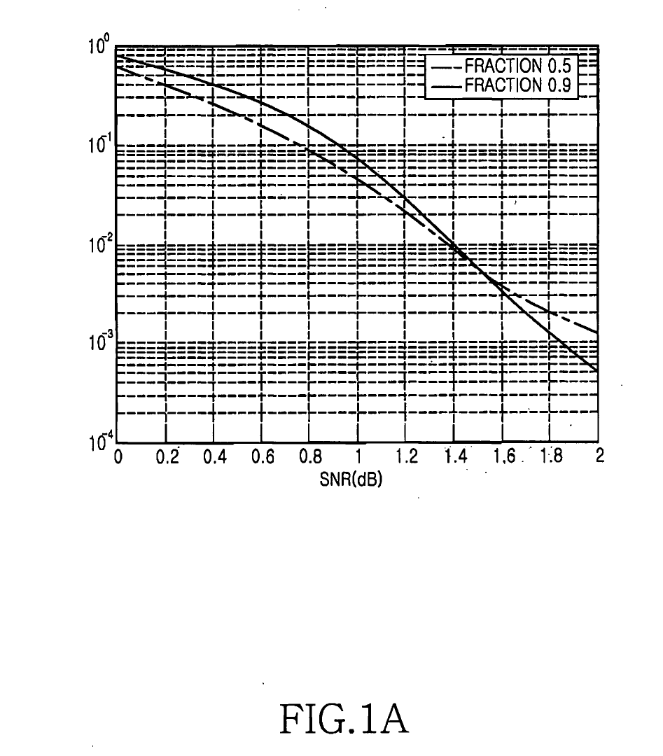

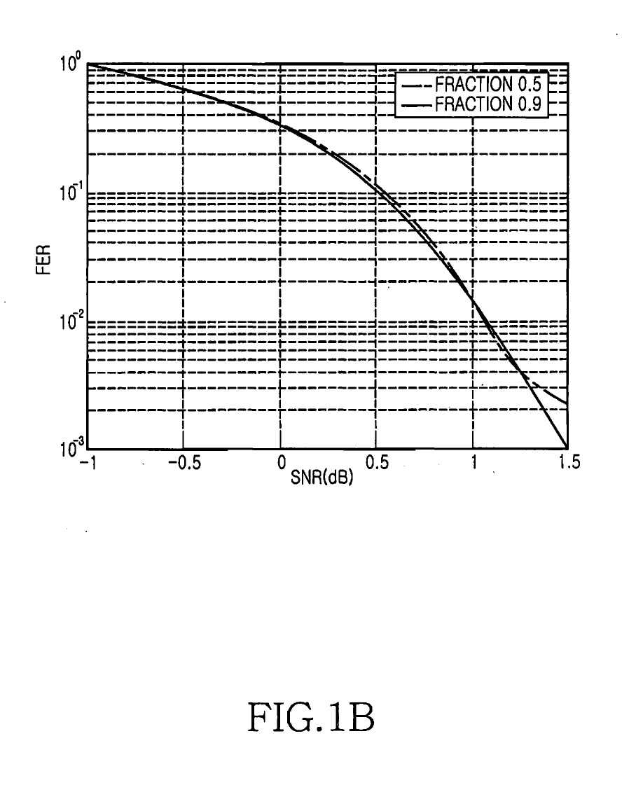

FIGS. 1A and 1B are graphs illustrating the performance of Frame Error Rate (FER) according to sub-carrier combining (SC).

FIGS. 1A and 1B are results of simulations when two sub-carriers are combined. FIG. 1A is a case using ⅓ turbo code as a code rate defined in the Code Division Multiple Access (CDMA) 2000 standard, and FIG. 1B using ¼ turbo code as a code rate defined in CDMA2000 standard. The terminology used herein is as follows: “fraction” is a ratio occupied by one sub-carrier in capabilities of sum of two sub-carriers, if the value of the fraction is “0.5”, it means that Signal to Noise Ratio (SNR) of two sub-carriers is same. As shown, if sum of capabilities of two sub-carriers is equal apart from the difference of capabilities between two sub-carriers, it means that performances of FER are similar. That is, the rate of channel combining a plurality of sub-carriers having different rates can be approximated to equal the sum of the rates (or capabilities) of each sub-carrier.

Conditions in the present invention are as follows.

First, the multicast service should be performed to all corresponding users in reliable transmission. That is to say, the rate of the multicast service should be determined as the minimum value among the required multicast rates of the users.

Second, the unicast service should assure the maximum rate by the user since it is enough to transmit only to one corresponding user.

Third, the multicast service should be used prior to the unicast service.

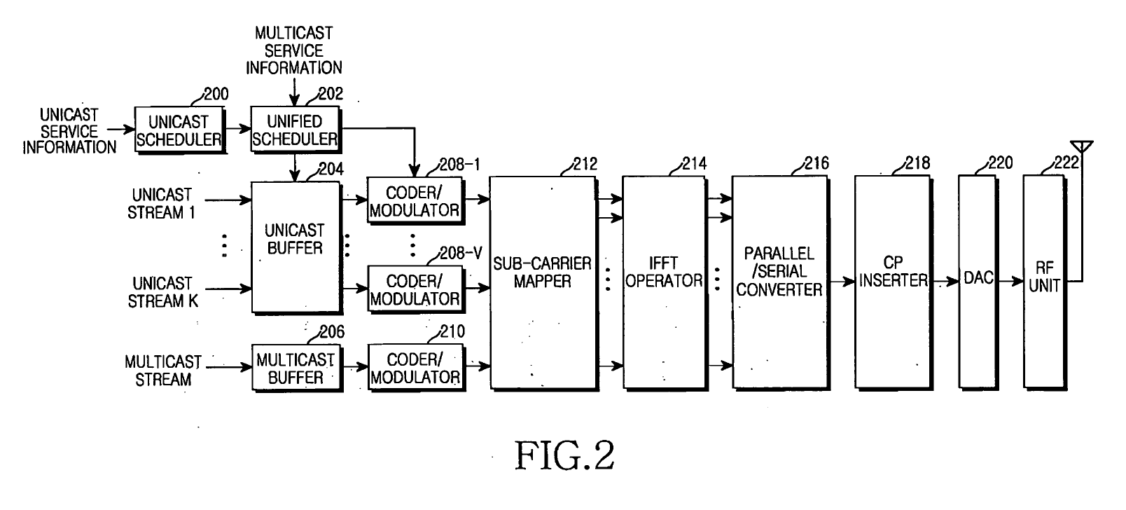

FIG. 2 is a block diagram of a transmitter in a multi-carrier wireless telecommunication system in accordance with the present invention.

As shown in FIG. 2, the transmitter includes a unicast scheduler 200, a unified scheduler 202, a unicast buffer 204, a multicast buffer 206, coders/modulators 208-1 to 208-V and 210, a sub-carrier mapper 212, an inverse fast Fourier transform (IFFT) processor 214, a parallel/serial converter 216, a cyclic prefix (CP) inserter 218, a digital to analog converter (DAC) 220 and a radio frequency (RF) unit.

Referring to FIG. 2, the unicast scheduler 200 determines a unicast rate for each sub-carrier by performing a scheduling using unicast service information (e.g. channel information), and then outputs the unicast rate. The unified scheduler 202 determines a set of sub-carriers for multicast service (hereinafter referred to as multicast sub-carrier set) by performing scheduling using the multicast service information (e.g. channel information) and the unicast scheduling result from the unicast scheduler 200. Also, the unified scheduler 202 allocates to the unicast service sub-carriers except for the sub-carriers for the multicast service.

The unicast buffer 204 buffers a plurality of unicast streams (stream 1 to stream k) being input, and selects the unicast streams to be transmitted under the unified scheduler 202. Each of the coders/modulators 208-1 to 208-V codes/modulates a unicast stream from the unicast buffer 204 according to the predetermined MCS level.

The multicast buffer 206 buffers the multicast stream being input. The coder/modulator 210 codes/modulates the multicast stream from the multicast buffer 204 according to the predetermined MCS level.

The sub-carrier mapper 212 maps to the corresponding sub-carrier data (modulated symbols) from the coders/modulators 208-1 to 208-V under the control of the unified scheduler 202, and outputs the data. Herein, to map data to a corresponding sub-carrier is to provide each of the modulated symbols to the corresponding input of the IFFT processor 214. The sub-carrier mapper 212 according to the present invention maps the multicast data to the sub-carriers included in the multicast sub-carrier set and maps the unicast data to the sub-carriers out of the multicast sub-carrier set. Herein, the multicast sub-carrier set is defined to maximize the total transmission efficiency of unicast traffic while assuring a uniform rate to all of the multicast users.

The IFFT processor 214 outputs data in the time domain by IFFT transforming the data from the sub-carrier. The parallel/serial converter 216 transforms the parallel data from the IFFT processor 214 into serial data. The CP inserter 218 inserts a guard period into the data from the parallel/serial converter 216. The DAC 220 transforms sample data from the CP inserter 218 into analog signal. RF unit 222 transforms base band signal to RF band signal, transmits the RF band signal via an antenna.

As described above, a sub-carrier set for multicast service is formed to maximize transmission efficiency of the unicast traffic while assuring a uniform rate to all of the multicast users for the multicast service. This is expressed as Equation (1)

$$max {\sum }_{n - 1}^{N} {U}_{n} ( 1 - {w}_{n} ) ≡ {\sum }_{n - 1}^{N} {U}_{n} - min {\sum }_{n - 1}^{N} {U}_{n} {w}_{n} \\ s . t . min {\sum }_{n - 1}^{N} {R}_{k , n} {w}_{n} \geq {R}_{req} , 0 \leq {w}_{n} \leq 1 \qquad ( 1 )$$

where N is the number of sub-carrier, Uₙ is the unicast rate of sub-carrier n, R_{k,n} is the rate at sub-carrier of multicast user k, wₙ is the ratio allocated sub-carrier n to multicast, and R_{req} is the required multicast rate.

Equation (1) can be solved by linear programming (LP). It is impossible to calculate LP in real time due to the high complexity of the processing. Also, since to change the usage of sub-carrier at a time slot in real system is impossible, wₙ should be “0” or “1”

The present invention proposes a scheme for allocating the sub-carriers on a one by one basis to the multicast traffic until the required multicast rate is satisfied. In this case, there should be criteria that determine how to correctly allocate any sub-carrier to the multicast traffic. In the present invention, the criteria is defined as a multicast preference. That is, the multicast channel is configured by calculating the multicast preference for each sub-carrier and allocating the sub-carrier with the maximum preference to the multicast traffic.

The multicast preference is calculated by Equation (2).

$${q}_{n} = \frac{1}{{U}_{n}} {max}_{k ∈ B} ( \frac{{R}_{k , n}}{{\sum }_{m ∈ A} {R}_{k , m} - {R}_{k}^{req}} ) \qquad ( 2 )$$

where A={n|wₙ=0} is a set of sub-carriers that is not yet allocated as multicast,

$${R}_{k}^{req} = max [ {R}_{req} - {\sum }_{n ∉ A} {R}_{k , n} , 0 ]$$

is an additional rate that is necessary to satisfy required multicast rate for user k, B={k|Rₖ^{req}>0} is a set of users that have not satisfied the required multicast rate, Uₙ is a unicast rate for nth sub-carrier, and R_{k,n} is a rate that is able to be used by multicast user k at sub-carrier n.

The present invention is fundamentally a scheme for allocating a sub-carrier of which the multicast rate is relatively greater by comparing rates when each of the multicast and the unicast is transmitted to the multicast in priority. The unicast rate is determined by scheduling in advance, and it is difficult for the multicast to determine a specific value for the multicast rate since the multicast rate is different for each user. Therefore, the preference in Equation (2) the post part of “max” can be a part calculating the effective multicast rate according to any additional rate required and the overall channel state.

In the Equation (2),

$${\sum }_{m ∈ A} {R}_{k , m}$$

notes that the rate can be determined from the sub-carriers not yet allocated to the multicast. That is, a value of that is large means that sub-carriers in a good state among sub-carriers the have not yet been allocated remain enough. If the difference

$${\sum }_{m ∈ A} {R}_{k , m} - {R}_{k}^{req}$$

between the rate of the remaining sub-carriers and the additional rate required is greater, user k is easy to satisfy the required rate of the multicast traffic, otherwise, user k is difficult to satisfy the required rate of the multicast traffic.

Because the rate requirements are satisfied for all users when the multicast is serviced, resource allocation is necessary with the strictest criteria of a requirement for effectively allocating resources. In this meaning,

$$\frac{1}{{\sum }_{m ∈ A} {R}_{k , m} - {R}_{k}^{req}}$$

is constructed by allocating weight for user k. That is to say, because it is difficult to satisfy the requirement of a user in the maximum value, the solution of the multicast rate for each sub-carrier is determined by the rate of the user.

Within the framework of the description above, the post part of “max”

$$\frac{{R}_{k , n}}{{\sum }_{m ∈ A} {R}_{k , m} - {R}_{k}^{req}}$$

can be the rate of the multicast applied weight, and the maximum value of these is considered as the effective multicast rate corresponding to the sub-carrier. Also, the ratio between the effective multicast rate and the unicast rate Uₙ is defined as the multicast preference.

As can be understood from the foregoing description, the multicast preference is defined as ratio between the multicast rate and the unicast rate. Also, the multicast rate for each sub-carrier is defined as the maximum value among weighted rates of each multicast user. Also, the weighted value of the multicast rate is determined by the difference between the rate that can be given from the sub-carriers of the remaining corresponding user and the rate requirement to be additionally serviced.

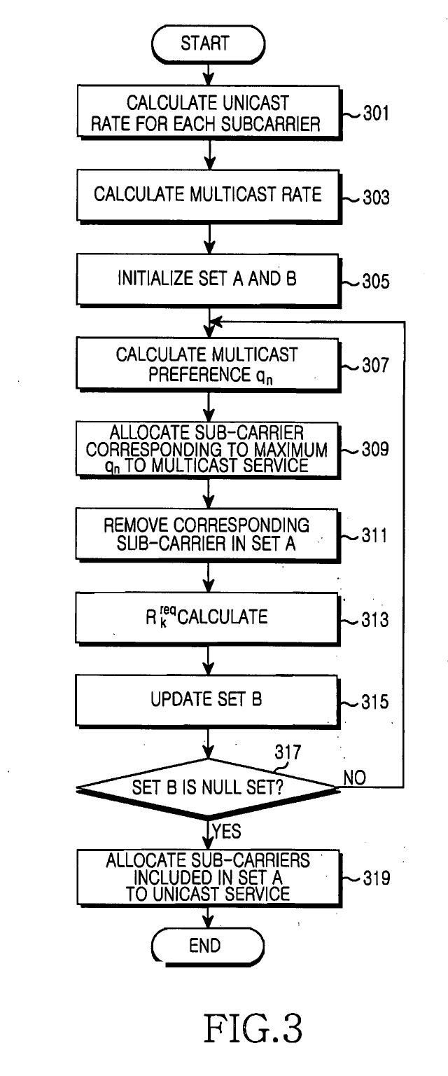

FIG. 3 is a flowchart showing resources allocation procedure to service a unicast service and a multicast service at the same time in a multi-carrier wireless telecommunication system according to the present invention.

Referring to FIG. 3, the unified scheduler 202 determines the unicast rate Un about sub-carrier n in step 301. The unicast rate about sub-carrier n can be determined through the scheduling about the unicast service. The unified scheduler 202 calculates the rate R_{k,n} of unicast user k's sub-carrier m and determines the required multicast rate on the basis of the multicast users' channel conditions. Rate R_{k,n} is calculated using feedback channel information (e.g. channel quality indication (CQI) information) from user k.

The unified scheduler 202 configures a set A and a set B on the basis of the contents determined in step 305. Set A indicates the set of sub-carriers that are not yet allocated to the multicast, and set B indicates the set of the multicast users that are not yet satisfied with the required multicast rate.

After configuring set A and set B, the above unified scheduler 202 progresses to step 307 and then calculates the multicast preference qₙ about set B corresponding each sub-carrier included in set A. The above preference qₙ is calculated with the Equation (2). After calculating multicast preference qₙ about each sub-carrier included in set A, the unified scheduler 202 chooses the maximum out of the preferences qₙ calculated in step 309, and then allocates the sub-carrier corresponding to the maximum qₙ to the multicast service.

The unified scheduler 202 removes corresponding sub-carriers in set A in step 311 and calculates Rₖ^{req} for satisfying the required multicast rate of the multicast user in step 313. The above unified scheduler 202 updates set B on the basis of the additional rates calculated in step 313. Set B is configured with the users having the above additional rate over “0”

After updating set B, the unified scheduler 202 determines if set B is null set. Unless the above set B is null set, the unified scheduler 202 performs the following steps at step 307. If set B is a null set, the unified scheduler 202 progresses into step 319 and allocates the sub-carriers included in set A to the unicast service.

After a set (or combining) of sub-carriers for the multicast service is determined, total transmission efficiency of the unicast service can be maximized securing a uniform rate for all the multicast users.

For example, sub-carrier combining (or sub-channel combining) is assumed as shown in Table 1.

TABLE 1

| | sub-channel | | | | |
|---|---|---|---|---|---|
| | 1 | 2 | 3 | 4 | 5 |
| user 1 | 3 | 2 | 6 | 5 | 1 |
| user 2 | 5 | 6 | 3 | 1 | 4 |
| allocation | M | U2 | M | U1 | U2 |

Table 1 shows that the result of the rate and the allocation to the sub-channel of each user in the case of 5 sub-channels, 2 users and a required multicast rate of 8. In the case of user 1, data received at rate 3 is available to sub-channel 1, data received at rate 2 is available to sub-channel 2, data received at rate 6 is available to sub-channel 3, data received at rate 5 is available to sub-channel 4, and data received at rate 1 is available to sub-channel 5. This represents that each sub-channel of M, U1, U2 in “allocation” is allocated to each of multicast, unicast user 1 and unicast user 2.

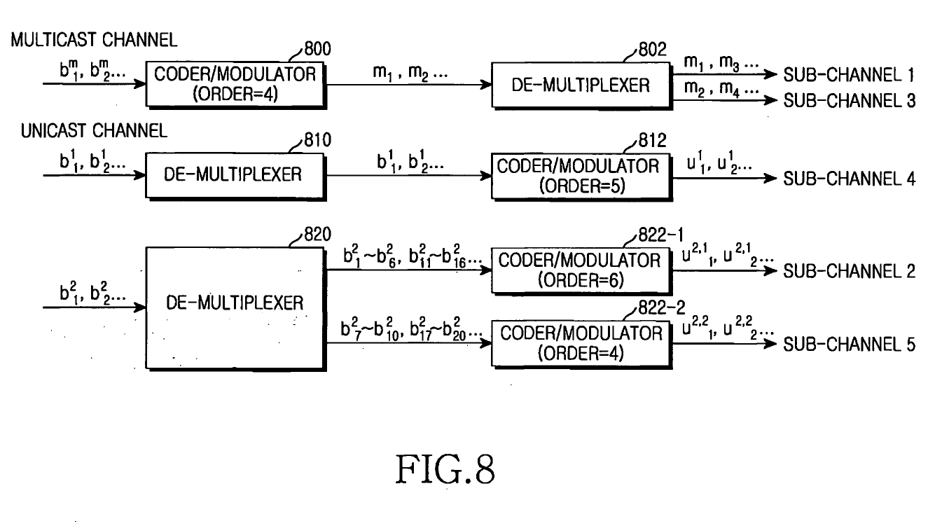

Referring to FIG. 8, “b” indicates data bits. Upper subscript m indicates the multicast, and upper subscript 1 and 2 means unicast user 1 and 2, respectively. m indicates the multicast symbol passing through the coder/modulator 800. u indicates the unicast symbol, and upper subscript x, y indicates a symbol transmitted to the yth sub-channel of user x. Inferior subscript indicates each index of the bit/symbol stream.

In the case of a multicast channel, rate 8 should be achieved in the combined two channels. Therefore, the order that is coded and modulated became “4” 4 bits (b^{m}₁˜b^{m}₄) are mapped into one symbol. The above symbols (m₁, m₂, . . . ) are de-multiplexed through de-multiplexer 802 and transmitted to sub-channel 1 and sub-channel 3. In other words, odd symbols (m₁, m₃, . . . ) are transmitted to sub-channel 1 and even symbols (m₂, m₄, . . . ) are transmitted to sub-channel 3. The sum total of the sub-channel 1 rate and sub-channel 3 rate is 9 to user 1 and 8 to user 2, therefore two users can restore their data. In a similar manner, the multicast data is coded and modulated through one coder/modulator, and then transmitted through multicast sub-channels. In other words, a data bit number that a symbol includes to different mapping sub-channel is same.

Only one sub-channel is allocated to the unicast channel of user 1, therefore transmitting data can be sent to sub-channel 4 via one coder/modulator 812.

Sub-channels 2 and 5 are allocated to the unicast channel of user. 2, therefore transmitting data can be de-multiplexed and sent with different rates. Data bits (b²) are de-multiplexed through de-multiplexer 820 and then the above data are transmitted each to sub-channel 2 and sub-channel 5 through different coder/modulator 822-1 and coder/modulator 822-2. Each rate of sub-channel 2 and sub-channel 5 is 6 and 4, respectively, therefore, 6 bits (b²₁˜b²₆) are transmitted to sub-channel 2 through coder/modulator 822-1 and 4 bits (b²₇˜b²₁₀) are transmitted to sub-channel 5.

Symbols mapped to the sub-channel comprise an OFDM symbol through IFFT processing and are transmitted. In the FIG. 8, symbols first input to the IFFT processor are changed into m₁, u^{2,1}₁, m₂, u¹₁, u^{2,2}₁.

Simulation results to prove performance of the present invention are as follows.
Each user's channel conditions have independent and equal distribution.
30 sub-carriers are supposed under the conditions of 8 Rayleigh multitude channels.

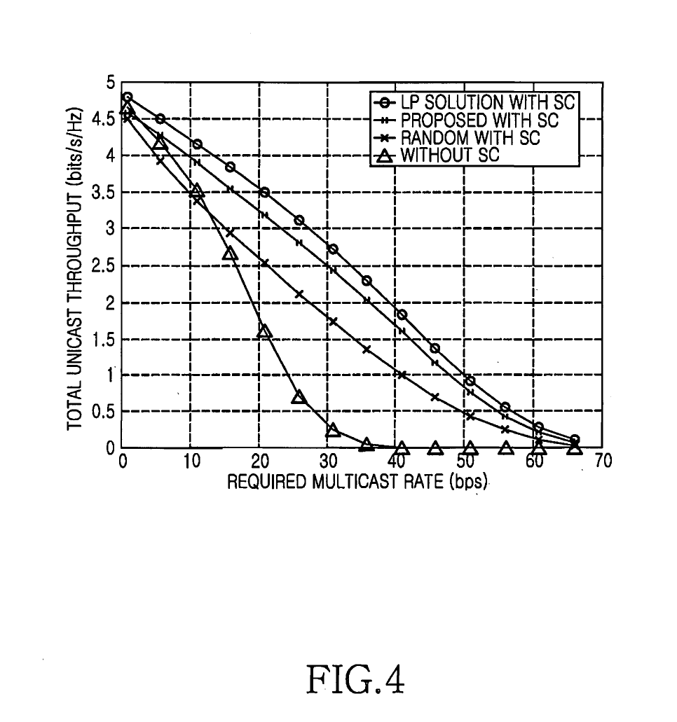

“LP solution with SC” on FIG.4 to FIG.7 expresses upper bound of performance. “Proposed with SC” expresses a scheme proposed in the present invention, and “random with SC” expresses the case that multicast channel is configured by random sub-carriers with SC. Also, “without SC” expresses the case that total transmission efficiency is maximized without SC.

FIG. 4 is a graph illustrating the relation between required multicast rate and total unicast throughput.

On the result of experiment with 10 multicast users and 10 unicast users, as illustrated, the scheme proposed in the present invention (proposed with SC) most approaches upper bound of performance (LP solution with SC).

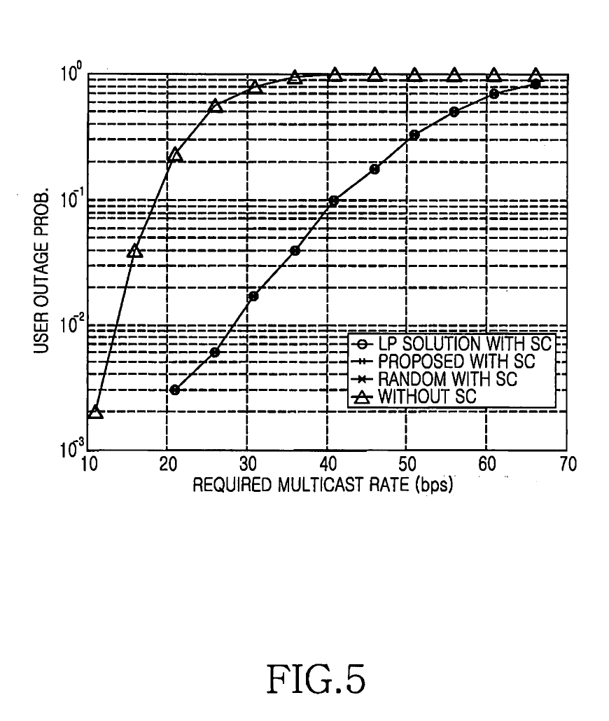

FIG. 5 is a graph illustrating the relation between required multicast rate and outage probability.

As illustrated, while the case with SC conducts similar performance, there is a strong outage probability about the same required multicast rate in the case without SC. The above outage probability shows the rate of users that are not satisfied with the required multicast rate.

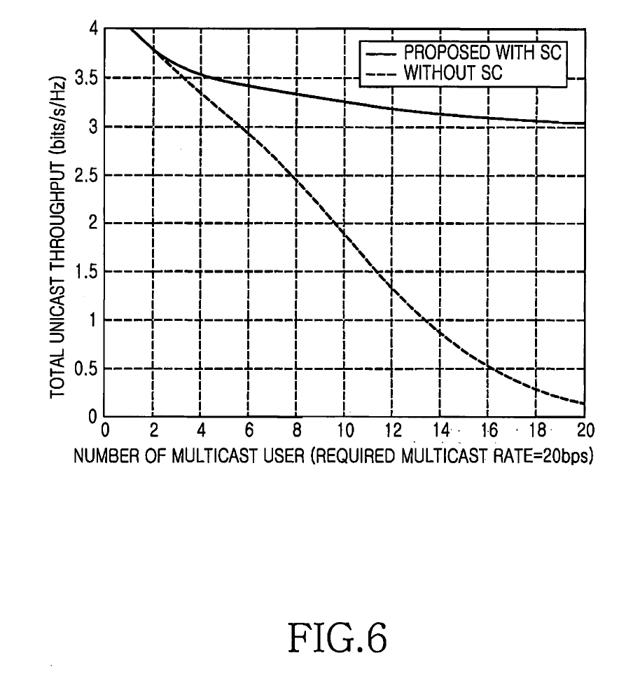

FIG. 6 is a graph illustrating the showing relation between the number of multicast user and total unicast throughput.

On the result of experiment with 20 multicast users and 10 unicast users, as illustrated, the greater the number of multicast users, the more the total unicast throughput decreases in the case without SC. However, though the number of multicast user increases, the total unicast throughput changes little in the present invention with SC.

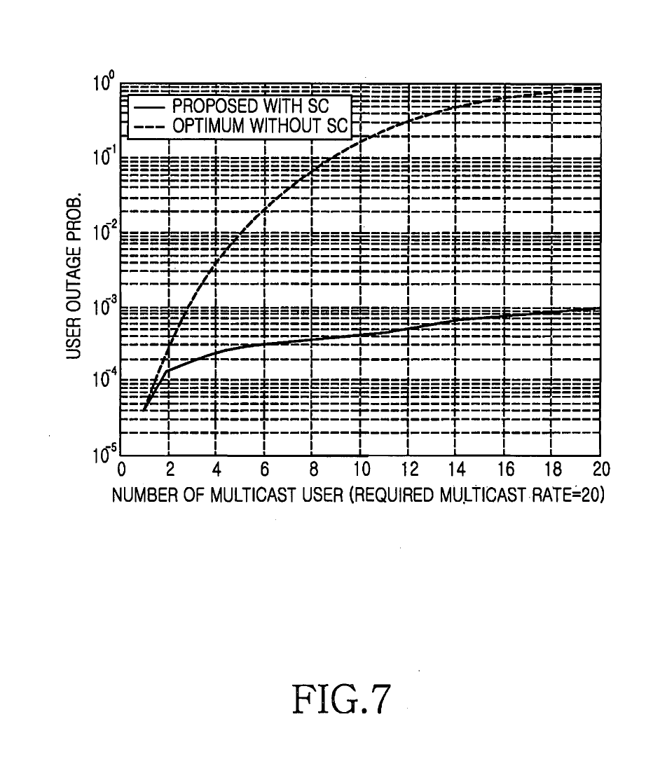

FIG. 7 is a graph illustrating the relation between the number of multicast user and outage probability.

As illustrated, the greater the number of multicast users, the more the outage probability increases in the case without SC. However, though the number of multicast user increases, the outage probability changes little in the present invention with SC.

As described above, the present invention has an advantage that increases transmission efficiency of unicast with assuring multicast rate when multicast services and unicast services are disordered in multi-carrier telecommunication system. That is, the present invention is able to provide multicast service and unicast service at once.

While the invention has been shown and described with reference to an exemplary embodiment thereof, it will be understood by those skilled in the art that various changes in form and details may be made therein without departing from the spirit and scope of the invention as defined by the appended claims.

What is claimed is:

1. An apparatus for allocating resources in multi-carrier telecommunication system, the apparatus comprising:
a scheduler for configuring a multicast channel by combining sub-carriers according to a multicast preference for each sub-carrier, and controlling resource allocation according to the configured multicast channel; and
a sub-carrier mapper for allocating multicast data to the sub-carriers of the multicast channel under the control of the scheduler, and allocating unicast data to sub-carriers excluding the sub-carriers allocated to the multicast channel.

2. The apparatus of claim 1, wherein the scheduler determines a multicast rate and a unicast rate for each sub-carrier, and a preference based on a ratio between the multicast rate and the unicast rate.

3. The apparatus of claim 2, wherein the unicast rate for each sub-carrier is determined by a schedule for the unicast service.

4. The apparatus of claim 2, wherein the multicast rate for each sub-carrier is determined based on the rate of users satisfied with a required lowest level multicast rate among multicast users.

5. The apparatus of claim 1, wherein the scheduler determines multicast preference for nth sub-carrier using
$${q}_{n} = \frac{1}{{U}_{n}} {max}_{k ∈ B} ( \frac{{R}_{k , n}}{{\sum }_{m ∈ A} {R}_{k , m} - {R}_{k}^{req}} )$$
where A={n|wₙ=0} is a set of sub-carriers that is not yet allocated as multicast,
$${R}_{k}^{req} = max [ {R}_{req} - {\sum }_{n ∉ A} {R}_{k , n} , 0 ]$$
is an additional rate that is necessary to satisfy required multicast rate for user k, B={k|Rₖ^{req}>0} is a set of users that are not satisfied with required multicast rate, Uₙ is unicast rate for nth sub-carrier, and R_{k,n} is a rate that is able to be used by multicast user k at sub-carrier n.

6. The apparatus of claim 1, wherein if a set of sub-carriers that is not allocated to the multicast is a first set and a set of users that are not satisfied with the required multicast rate R_{req} is a second set, the scheduler calculates a preference of the second set for each sub-carrier in the first set, and performs an operation that includes a sub-carrier corresponding to a maximum value among the calculated preferences to the multicast channel.

7. The apparatus of claim 6, wherein the scheduler configures the multicast channel by repeating the operation until the second set is a null set.

8. The apparatus of claim 1, further comprising:
a plurality of coders/modulators for providing unicast streams to the sub-carrier mapper by coding and modulating the unicast streams; and
a multicast coder/modulator for providing a multicast stream to be transmitted to the sub-carrier mapper by coding and modulating the multicast stream.

9. The apparatus of claim 1, further comprising:
an OFDM modulator for an OFDM modulating data received from the sub-carrier mapper; and
a RF unit for transmitting a RF band signal by transforming a signal received from the OFDM modulator to an RF band signal.

10. The apparatus of claim 1, the scheduler comprising:
a unicast scheduler for determining a unicast rate for each sub-carrier by performing a schedule according to channel information feedback from a unicast user; and
a multicast scheduler for determining an effective multicast rate for each sub-carrier, determining the preference based on a ratio between the effective multicast rate and the unicast rate, and controlling resource allocation by configuring multicast channel according to the preference.

11. A method for allocating resources in multi-carrier telecommunication system, the method comprising:
configuring a multicast channel by combining sub-carriers according to a multicast preference for each sub-carrier;
allocating data to be transmitted to the sub-carriers configuring the multicast channel; and
allocating to sub-carriers excluding the sub-carriers allocated to the multicast channel unicast data to be transmitted.

12. The method of claim 11, wherein configuring a multicast channel comprises:
determining a multicast rate and a unicast rate for each sub-carrier;
determining a preference for each sub-carrier based on a ratio between the multicast rate and the unicast rate; and
including sub-carriers corresponding to a maximum value among the calculated preferences to the multicast channel

13. The method of claim 12, wherein the unicast rate for each sub-carrier is determined by scheduling for unicast service.

14. The method of claim 12, wherein the multicast rate for each sub-carrier is determined based on the rate of users satisfied with a lowest level required multicast rate among multicast users.

15. The method of claim 11, wherein the multicast preference for nth sub-carrier is determined by
$${q}_{n} = \frac{1}{{U}_{n}} {max}_{k ∈ B} ( \frac{{R}_{k , n}}{{\sum }_{m ∈ A} {R}_{k , m} - {R}_{k}^{req}} )$$
where A={n|wₙ=0} is a set of sub-carriers that is not yet allocated as multicast,
$${R}_{k}^{req} = max [ {R}_{req} - {\sum }_{n ∉ A} {R}_{k , n} , 0 ]$$
is additional rate that is necessary to satisfy required multicast rate for user k, B={k|Rₖ^{req}>0} is a set of users that are not satisfied with required multicast rate, Uₙ is unicast rate for nth sub-carrier, and R_{k,n} is rate that is able to be used by multicast user k at sub-carrier n.

16. The method of claim 11, wherein configuring a multicast channel, comprises:
forming a first set with sub-carriers that are not allocated to the multicast;
forming a second set with users that are not satisfied with the required multicast rate R_{req};
calculating a multicast preference of the second set for each sub-carrier in the first set; and
including a sub-carrier corresponding to a maximum value among the calculated preferences to a multicast channel.

17. The method of claim 16, wherein an update of the multicast channel is repeated until the second set is a null set.

18. The method of claim 11, further comprising:
generating the unicast data by coding and modulating each unicast stream to be transmitted; and
generating the multicast data by coding and modulating the multicast stream to be transmitted.

19. The method of claim 11, further comprising:
OFDM modulating the data allocated to a sub-carrier; and
transmitting a RF band signal by transforming the OFDM modulated signal to an RF band signal.

20. A method for allocating resources in multi-carrier telecommunication system, the method comprising:
forming a first set with sub-carriers that are not allocated to a multicast;
forming a second set with users that are not satisfied with a required multicast rate R_{req};
calculating a multicast preference of the second set for each sub-carrier in the first set;
including a sub-carrier corresponding to a maximum value among the calculated preferences to a multicast channel;
excluding the sub-carrier included in the multicast channel from the first set;
updating the second set; and
configuring the multicast channel by repeating the above steps until the second set is a null set.

21. The method of claim 20, wherein the calculating step comprises:
calculating a rate for nth sub-carrier of the first set by considering a resource allocation weight for each user included in the second set; and
determining a ratio between a multicast rate corresponding to a maximum value among the calculated rates and the unicast rate for nth sub-carrier to a preference for nth sub-carrier.

22. The method of claim 20, wherein the updating step comprises:
calculating an additional rate to be satisfied with the required multicast rate for each of the multicast users; and
forming the second set with users having the additional rate greater than zero.

23. The method of claim 20, further comprising:
coding and modulating a multicast stream; and
mapping the modulated data to sub-carriers corresponding to the multicast channel.

24. A method for allocating resources in multi-carrier telecommunication system, the method comprising:
configuring a multicast channel by combining sub-carriers according to a multicast preference for each sub-carrier;
allocating a encoding packet to a sub-carrier of the multicast channel by encoding a multicast stream to be transmitted;
allocating different encoding packets to sub-carriers excluding sub-carriers allocated to the multicast channel by coding each of a plurality of unicasts to be transmitted.

25. The method of claim 24, wherein the configuring step comprises:
determining a multicast rate and a unicast rate for each sub-carrier;
determining a preference for each sub-carrier based on a ratio between the multicast rate and the unicast rate; and
including a sub-carrier corresponding to a maximum value among the determined preferences to multicast channel.

26. The method of claim 25, wherein the unicast rate for each sub-carrier is determined by a schedule for a unicast service.

27. The method of claim 25, wherein the multicast rate for each sub-carrier is determined based on the rate of users satisfied with a lowest level required multicast rate among the multicast users.

28. The method of claim 24, wherein the multicast preference for nth sub-carrier I determined by
$${q}_{n} = \frac{1}{{U}_{n}} {max}_{k ∈ B} ( \frac{{R}_{k , n}}{{\sum }_{m ∈ A} {R}_{k , m} - {R}_{k}^{req}} )$$
where A={n|wₙ=0} is a set of sub-carriers that is not yet allocated as multicast,
$${R}_{k}^{req} = max [ {R}_{req} - {\sum }_{n ∉ A} {R}_{k , n} , 0 ]$$
is additional rate that is necessary to satisfy required multicast rate for user k, B={k|Rₖ^{req}>0} is a set of users that are not satisfied with required multicast rate, Uₙ is unicast rate for nth sub-carrier, and R_{k,n} is rate that is able to be used by multicast user k at sub-carrier n.

29. The method of claim 24, wherein the configuring a multicast channel step, further comprises:
forming a first set with sub-carriers that are not allocated to the multicast;
forming a second set with users that are not satisfied with a required multicast rate R_{req};
calculating a multicast preference of the second set for each sub-carrier in the first set; and
including a sub-carrier corresponding to a maximum value among the calculated preferences to a multicast channel.

30. The method of claim 29, wherein an update of the multicast channel is repeated until the second set is a null set.
